(19) United States
(12) Patent Application Publication
(10) Pub. No.: US 2004/0119682 A1
(43) Pub. Date: Jun. 24, 2004

(54) Self-correcting autonomic mouse

(75) Inventors: James L. Levine, Yorktown Heights, NY (US); Steven J. Mastrianni, Unionville, CT (US); Michael A. Schappert, Wappingers Falls, NY (US)

Correspondence Address: Eric W. Petraske, 68 Old Hawleyville Road, Bethel, CT, 06801, US

(73) Assignee: International Business Machines Corporation, Armonk, NY (US)

(21) Appl. No.: 10/322,277

(22) Filed: Dec. 18, 2002

(51) Int. Cl. G09G 5/00; G09G 5/08

(52) U.S. Cl. 345/156; 345/158; 345/163

(57) ABSTRACT

Users with disabilities that hinder them from using a mouse or other pointing device are aided by a system that minimizes the effect of hand tremors or other motion difficulties on the display produced by a pointing device; in which the mouse automatically adjusts on the fly to the user's habits; the mouse properties automatically adjust to the type of object being selected; and the mouse output is processed by a smoothing filter to suppress small variations about the intended motion.

### TECHNICAL FIELD

The field of the invention is that of pointing devices for computers and associated software, such as a mouse or mouse-like input device, in particular modifying the output of the pointing device to accommodate persons with disabilities.

### BACKGROUND OF THE INVENTION

Many individuals have difficulty using a mouse or mouse-like device for a variety of reasons that are not necessarily the result of a disability. Ambient lighting, display brightness, display contrast, and marginal mechanical or electrical devices all contribute to difficulty in using a mouse.

To provide equal employment opportunities to people with disabilities, the United States government has mandated that all software purchased by the government must adhere to section 508 of the Rehabilitation Act of 1973 as amended (29 U.S.C. Section 794d). In order to meet these guidelines, companies have re-engineered computer hardware and computer software to accommodate persons with disabilities. Various types of disabilities exist, including color blindness, deafness, blindness, dyslexia, various types of cognitive disabilities, and motor disabilities.

Among the motor disabilities, a frequent category of disabilities is one that manifests itself in the form of tremors or uncontrolled muscle movements like those exhibited by persons with Parkinson's disease. This type of mild disability also occurs as a result of the normal aging process.

The mouse has become an important part of the human-computer interaction. It is difficult to operate a PC without one. Persons with muscle tremors have a difficult time using a mouse as the settings for the mouse are themselves difficult to locate, and once configured, these parameters generally need frequent tuning to insure operation with various types of software.

Some types of software require fine granularity when selecting points, while others require only a general proximity with very coarse granularity of points. Locating the points to click, especially when a person's hand is shaking or moving uncontrollably can be difficult and prevent the user from operating the program. Locating a particular point in a low light situation, or where the user has trouble distinguishing the particular point from others because of vision problems or marginal mouse hardware can be very frustrating.

### SUMMARY OF THE INVENTION

The present invention relates to a system and method for controlling a mouse or mouse-like input device using autonomic behavior that allows users with hand tremors the ability to use a mouse by minimizing the effects of these tremors on the movement of the mouse.

A feature of the invention is the sensing of the user's habits, and adjusting the mouse automatically and autonomically ‘on the fly’ based on the user's movements, speed of movements (acceleration, velocity), type of movements (short jerks, long strokes).

Another feature of the invention is adaptation to the type of objects being referenced.

Another feature of the invention is magnification of the view of the area around the selected point or points, allowing a point to be more easily selected, using an amount of magnification and granularity based on the type of the object, such as an icon, a figure, or a thin line, and applying a different amount of magnification and resolution adjustment based on the type of object and type of program being used.

Yet another feature of the invention is the provision of a smoothing filter that when combined with the other features results in the smooth transition of the mouse from point to point at any resolution and at various rates of hand tremor.

Yet another feature of the invention is learning over time by observing the habits of each user, and keeping a profile of the user's habits, preferences, and settings.

The amount of smoothing can be set manually, and is adjusted automatically by the present invention by observing the user's behavior and applying automatic corrective adjustments. The system watches and observes how the mouse is being used, adjusts the behavior (resolution, filter) based on current usage on a program-by-program basis, and when the program is finished, saves the mouse settings to be used the next time that program is executed. Makes note of the problems encountered by the user and applies correction based on past successes and failures.

Detects difficulty in using the mouse. For example, if the user moves the mouse frequently in small movements without selecting an object, the system may detect that the user is having trouble selecting a particular line, pixel, or edge, and will adjust the resolution and rate accordingly. It will also optionally pop up a small magnifying glass of the general area of the mouse cursor. This magnified area moves with the mouse cursor. Offers contextual help when the user has trouble with the mouse operation, offering alternatives, shortcuts, or even offering to perform an operation on behalf of the user.

### BRIEF DESCRIPTION OF THE DRAWINGS

FIG. 1 illustrates a computer system upon which the present invention may be installed.

FIGS. 2A and 2B illustrate a drawing tablet and trackball with which the present invention may be operated.

FIG. 3 illustrates a sample of mouse data before and after applying the filter function.

FIG. 4 is a flow chart illustrating a sequence of operations involved in adjusting the parameters of the invention.

### DETAILED DESCRIPTION OF THE PREFERRED EMBODIMENT

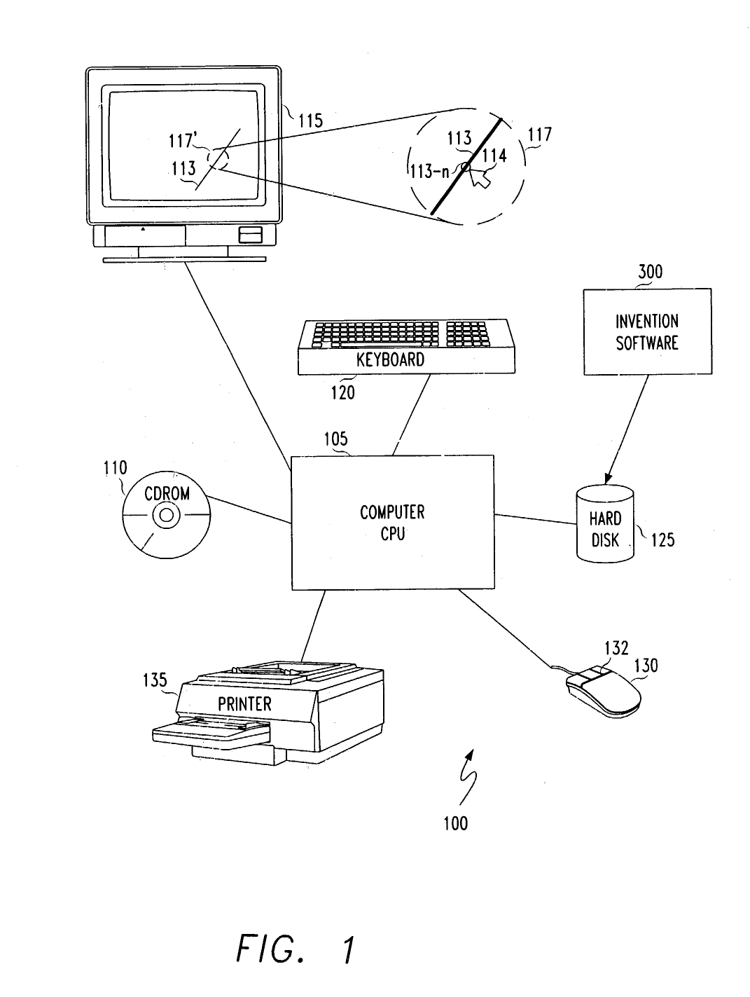

The present invention consists of a software application program and driver program, referred to as the autonomic mouse software, that is installed on a computer system 100. The computer system 100 can be any type of computer system, including a large mainframe style computer, a personal computer, a hand held computing device, a set-top computer, or any other type of computer that may be fitted or equipped with a mouse or mouse-like pointing device 130, hereafter referred to as the mouse. The computer system of FIG. 1 includes a CPU 105, display 115, keyboard 120, hard disk 125 containing invention software 300 as well as operating system and application software, a printer 135 and a CDROM 110.

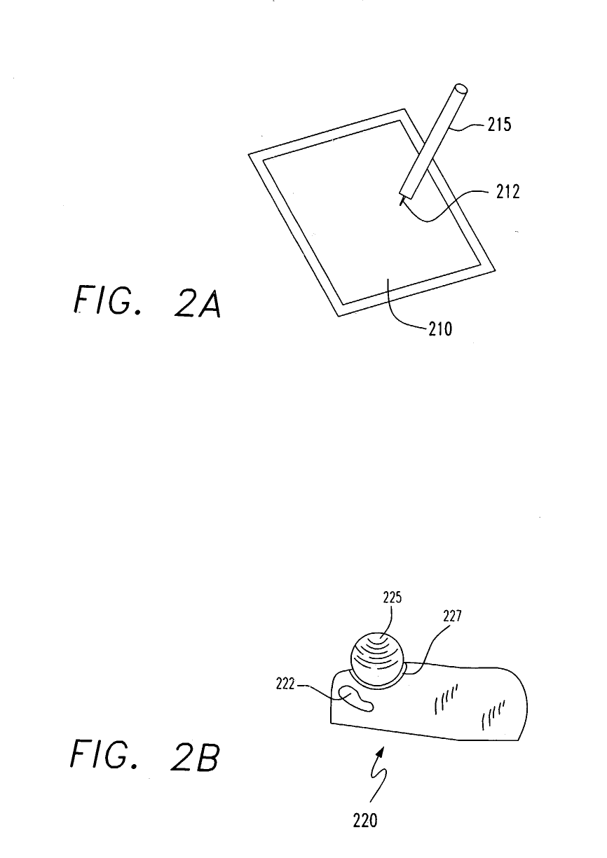

In operation, the mouse 130 sends signals reflecting movement of the device to the CPU, using a mechanism for tracking its movement in the X and Y direction. The mechanisms used to track this type of movement, such as resolvers, tachometers, or encoder feedback are well established and well known to anyone skilled in the art. In certain types of mouse devices, decoding of the X-Y position begins when the mouse 130 is placed on a flat surface. Some mouse devices, such as the common Trackball, do not require placement of the device on any type of surface but begin recording position changes (movements) immediately after they are powered on. Other mouse-like devices like a computer pen 215 in FIG. 2A used with a drawing tablet 210 require that the tip 212 be sufficiently depressed before the device will begin recording position changes. FIG. 2B shows a trackball, which generates motion signals in response to rotation of sphere 225 resting in aperture 227 (using a similar mechanism to the mouse).

The logical relative position of the mouse device in relation to the user's display or work area is usually indicated with a small icon shaped like a pointer or arrow 114 in FIG. 1. When the mouse device 130 is moved, the mouse hardware generates data points consistent with the type of mouse device. These data points are sent to the computer 100 using some type of communications including, but not limited to, serial, infrared, wireless radio, USB, or other methods. The data point values are captured by the computer 100 and used to indicate the position of the mouse pointer on the user's desktop or display. The data points are usually relative to each other, but may also be absolute.

The mouse device frequently contains other inputs such as switches (132 in FIG. 1 and 222 in FIG. 2B), knobs, adjusting dials, and potentiometers. Each of these sub-devices provides input or output data that is sent or received along with the coordinate data. The state of these sub-devices is represented in the form of data that is sent to the computer 100 with the coordinate data. For example, the state of a switch or button can be represented by a simple Boolean value of TRUE or FALSE, while the position of control can be represented by the digital equivalent of an analog value derived by applying the analog value to an analog to digital converter (ADC). Normally, the state of all the switches and controls is sent to the computer 100 when the mouse reports a coordinate change or when a switch or control value changes. The ability to read the values of these controls and convert the analog state to a digital equivalent is well known to anyone skilled in the art.

The rate at which the mouse sends the coordinate data, is controlled by the sampling rate of the mouse. The sampling rate is the time interval between sending updates to computer 100 when the data or control values are changing. The faster the sampling rate, the more often the coordinate data is updated and therefore the more often it is sent to the computer 100. If the mouse is being moved slowly with a fast sampling rate, much more data than necessary may be generated, resulting in sluggish mouse performance due to the large amount of data that has to be read and processed by the computer 100. If the sampling rate is set too slow, it may result in jerky mouse movements that make it difficult for the user to operate the mouse.

Using the sampling rate and positional data or a fixed period of time, we can calculate the acceleration and velocity of the mouse. We can also track the behavior of the user to determine if they are having trouble using the mouse. For example, if a user is observed trying to select a small line on the edge of a polygon but misses two out of three tries, we can conclude that they are having difficulty using the mouse on that particular type of shape or on data that is created or edited using a particular application.

For example, we know that the AutoCad(TM) program often is involved with creating and editing wire frame drawings. We also know that these drawings are most often viewed in a high-resolution mode of at least 1024×786 pixels. Using the mouse cursor to locate a single point to edit is difficult using the normal sized cursor and at the normal acceleration and sampling rates. Users who experience difficulty using the mouse because of visual problems, poor display brightness and contrast, or marginal mouse hardware will have even more difficulty than those who do not have such visual problems.

The present invention uses a table lookup to initialize the mouse to provide optimal settings for use with the current application. The lookup is based on the application type and screen resolution the system is currently operating in. It determines the current parameter values based on program type, program name, line width, color, size, and shape, and adjusts the mouse resolution based on an internal table of values for each object type. This autonomic behavior also takes into consideration the current display resolution of the adapter, and retains these settings on a per-user, per-display basis. This allows the user to change display resolution without losing their historical and empirical data, settings, and preferences.

During the current user's session, the activity of the mouse is logged. The present invention records the movements, acceleration, velocity, and success rate of the user's operations. For example, if the user tried several times to click on a point but continues to miss, the present invention might decrease the size of the mouse cursor, slow down the mouse movements by changing the sampling frequency, vary the resolution of the mouse, or by a combination of these parameters. Once a setting has been changed, the present invention begins the logging process once again, noting the user's activity and comparing it to the past activity. It then begins to make adjustments, if necessary, to the mouse settings, remembering which settings or combinations of settings provided the best results. The system continually monitors the mouse activity throughout the session, making small changes to incrementally improve the user's experience. It is important to note that this learned behavior is saved and retrieved on a per-user, per-application basic. A different user on the same machine with the same application will likely have a completely different set of parameters than any other user, and those optimal settings are used to setup the application the next time a particular user invokes it.

Referring to FIG. 4, there is shown a simplified flow chart of a monitoring procedure according to the invention. An initial step 410 sets up the system with the User's name, Program type (graphic, word processing, spreadsheet). A set of previously stored parameters, perhaps modified for that particular user during previous sessions, is retrieved and applied. The system then enters a loop in which it monitors the user's movements with the mouse. The application of a smoothing filter to smooth out the representation on the screen of the mouse movements in step 440 is discussed below.

When the user has attempted to click on an object N times without success, the system can put on the display a “magnifying window” in step 450, illustrated as circles 117 and 117′ in FIG. 1, in which a line 113 is shown in more detail with an enlarged cursor 114 that can point to an individual pixel 113-n on the line. The window is displaced from the display in the figure for convenience in illustration. In practice, it would be superimposed over the general display. This pattern of behavior will be referred to as “attempt mode” and may be used in connection with text programs or spreadsheets as well as graphics programs. Those skilled in the art will readily be able to establish many variations of triggering behavior, depending on selecting drawing tools (line, rectangle, etc.) and repeated attempts; repeated selection of individual letters in a word processing program, and the like.

Together with the magnifying window or separately, the system may decrease the spatial sensitivity of the pointing device; i.e. if the standard resolution is that 1 mm of motion of the mouse produces one pixel of motion on the screen, the ratio may be increased to 3 mm of motion per pixel, say. This makes fine motion on the screen easier to produce. It may be used together with the previous magnifying window or separately. A criterion for this mode, referred to as “resolution mode” is a decrease in speed of movement, such as is done when changing from a rapid movement to cross a sizable area of screen to a slower speed suitable for putting the cursor on an object, especially a small object.

A major component of usability for the present invention is the ability to modify the mouse sample data rate to provide a fewer number or greater number of data points, or to create addition data points to further define an arc or ellipse. The primary mechanism employed in the present invention to ‘smooth out’ the mouse movements is a software-based filter and its associated tables and algorithms that take the mouse input from the mouse device and operate on this data to provide the proper dampening and filtering functions. The use of such a filter according to the invention will be referred to as “smoothing mode”.

Software Filtering

When a mouse or other pointing device transmits data, an interrupt is generated in the computer that the mouse is attached to. The data is then received by a low-level device driver and passed to a higher-level device-driver for further processing. Eventually, this data is used to position the cursor on the display screen, select displayed objects, and so forth. Tremor filtering is performed within a supplementary device driver. When this driver is installed, the mouse data is intercepted after it is received by the computer but before it is used to position the cursor. A digital smoothing filter is applied to this data to preferentially remove high-frequency components caused by tremor, while leaving behind the low-frequency components representing the intended cursor movement. The filtered data is then returned to the regular device driver as if it had come directly from the mouse. Such filtering can be applied either to the motion increments received from a mouse, trackball, or other relative-motion sensing device, or to the position data received from touch screens, pen tablets, or other absolute-location sensing devices. We refer to any of these as a pointing device.

In most cases, a pointing device only sends data to a computer when the data is changing. This minimizes the computational overhead of receiving and processing the data. While motion is occurring, the data is normally sent at regular sampling intervals (Ts). Typical values for Ts are in the range 10 to 25 milliseconds. Thus, data from a mouse consists of a series of increments:

∂X(nTₛ)_{n=1,2,3} (1a)

∂Y(nTₛ)_{n=1,2,3} (1b

These data bursts are interspersed with periods of no activity. The data includes the state of the mouse buttons, and is also sent whenever a button changes state.

Filtering: Digital filtering is a well developed science, well known in the art. A very general method for calculating a series of filtered output values dX_{F} at times kTₛ (k=1, 2, 3 . . . ) from the input values of equations 1a and 1b is:

∂X_{F}(kTₛ)=Σₙ₌₁^{N}Aₙ∂X_{F}(k−n)+Σₘ₌₀^{M}Bₘ∂X(k−m) (2a)

∂Y_{F}(kTₛ)=Σₙ₌₁^{N}Aₙ∂Y_{F}(k−n)+ₘ₌₀^{M}Bₘ∂Y(k−m) (2b)

Here, N and M are predetermined integers, and Aₙ and Bₘ are a set of predefined coefficients. These values determine the properties of the filter, such as amplitude and phase shift with frequency, temporal response to an impulse, etc. There is a very large literature describing methods used to choose these values to produce a filter with a given set of requirements. We note here that some means is required to deal with the bursts of data, as equation 1 is derived on the assumption of continuous data sampling and processing. In particular, data processing ceases after each data burst as the filter device driver is only activated when data is received. This problem is solved by making use of the computer's timing function to generate interrupts at the sampling rate for some predetermined number of samples; i.e. once the mouse has started moving, a pause or cessation in the mouse motion will be filled by a slight extrapolation of previous data that the user's hand-eye coordination readily adjusts to.

Thus, processing can continue, moving the cursor as expected by the user based on its prior behavior. After the last such interrupt, the filter variables can be reset in anticipation of the next burst of data.

From equations 2a and 2b, the filter output depends not only on the past M data values dX(j) and dY(j), but may also depend on the past N filtered values dX_{F}(j) and dY_{F}(j). However, if the coefficients Aₙ are all zero, the filter output depends only on the last M data values, and stops M sample times after an impulse is applied to its input. Such a filter is referred to as a finite impulse response filter (FIR). If one or more values of Aₙ are non-zero, the response to an impulse continues for an indefinite time, and the filter is referred to as an infinite impulse response filter (IIR). Either type of filter can be used. Generally, FIR filters are less affected by digital round-off errors than IIR filters, but require more computations. With an FIR filter, cursor motion ceases abruptly N sample times after the input stops changing, which can be irritating to the user. Conversely, with an IIR filter, the cursor creeps slowly to a halt after mouse motion ceases, which can also be irritating to the user. However, in this case it is easy to include software to stop the cursor a predetermined number of sample times after mouse motion ceases.

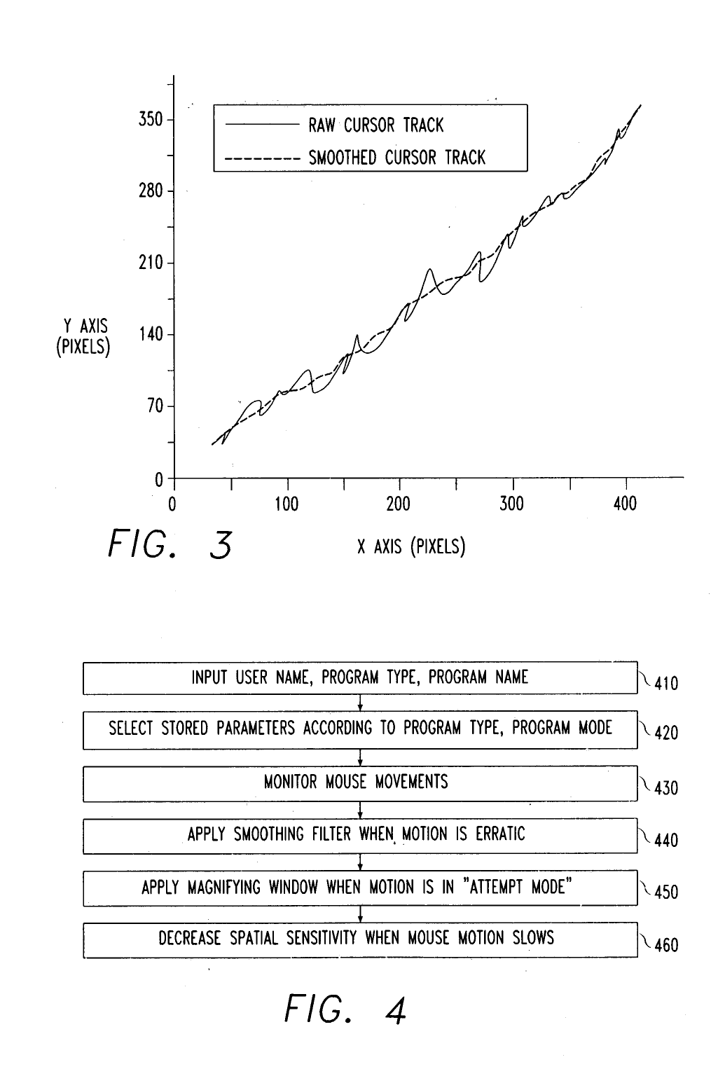

The filter used on the data of FIG. 3 is a simple IIR filter whose output uses the latest input value and the previous output value. The coefficients are chosen to make it a simple low-pass filter whose output approaches the input exponentially with time constant T:

∂X_{F}(kTₛ)=A₁∂X_{F}((k−1)Tₛ)+Bₒ∂X(kTₛ) (3a)

∂Y_{F}(kTₛ)=A₁∂Y_{F}((k−1)Tₛ)+Bₒ∂Y(kTₛ) (3b)

A1=1−(Tₛ/T) (3c)

B0=(Tₛ/T) (3d)

Such a filter has a relatively flat frequency response from zero to a cutoff frequency, where is given by:

F_{c}=1/(2πTau)F_{c}=1/(2πT) (4)

The response falls inversely with frequency above F_{c}. Although more complex filters can be used which cut off more rapidly, they introduce phase shifts which can be subjectively annoying. Furthermore, it is easier to adjust a single parameter to adapt the filter to a particular user.

Adjustment: Various methods can be used to customize the filter to suit a particular individual. For the IIR filter described by equations 3a-3d, the user can be presented with an on-screen “control panel” allowing selection of the time constant T. This might be activated by the keyboard in case the tremor was too high for mouse activation.

Alternatively, one might display two icons on the screen and ask the user to move the cursor up-and-back between them. The value of T could be adjusted to minimize the error between the cursor track and a straight line between the icons. This might be done repeatedly, perhaps stopping when the time required to go between the icons was minimized. Further, it would be practical to use a more complex filter (i.e. more than one coefficient) because the program would be adjusting the coefficients, rather than the user.

Juan G. Gonzalez (U. of Delaware thesis) described a program in which a user was asked to trace a random curve displayed on the screen with the mouse cursor. The coefficients of an extended FIR filter were than adjusted to minimize the mean square error between the mouse cursor track and the actual curve. Such a technique needs to be iterated because changing the filter affects the user's operation of the mouse.

Autonomic adjustment: All such past schemes for adjusting the filter require that the user take some action to initiate an adjustment, such as clicking an icon to invoke a program of the type discussed above. This may have to be done frequently, as tremor often varies considerably with time. A better alternative is to have an autonomic program running in the background which monitors the mouse activity, detects when the user is having trouble, and adjusts the filter to correct the problem.

While the invention has been described in terms of a single preferred embodiment, those skilled in the art will recognize that the invention can be practiced in various versions within the spirit and scope of the following claims.

What is claimed is:

1. In a computer system displaying data on a screen in response to inputs from a pointing device manipulated by a user, said system comprising operating software and receiving software means for receiving input data from said pointing device and displaying points on a screen, compensation software that intercepts data from said pointing device, modifies the intercepted data to form modified data and passes said modified data to said receiving software means, which modified data is modified to compensate at least partially for a disability of the user;
a method of classifying motion of said pointing device in one of at least two modes and applying stored parameters to modify said intercepted data according to the mode currently classified.

2. A method according to claim 1, further comprising a step of:
in a graphics program, decreasing the spatial sensitivity of said pointing device when the user is operating in attempt mode.

3. A method according to claim 1, further comprising a step of:
in a graphics program, converting displayed data on said display device to increase the size of objects within a magnifying window when the user is operating in attempt mode.

4. A method according to claim 2, further comprising a step of:
in a graphics program, converting displayed data on said display device to increase the size of objects within a magnifying window when the user is operating in attempt mode.

5. A method according to claim 1, further comprising a step of:
in a graphics program, converting displayed data on said display device to increase the size of objects within a magnifying window when the user is operating in resolution mode.

6. A method according to claim 1, further comprising a step of:
in a graphics program, decreasing the spatial sensitivity of said pointing device when the user is operating in attempt mode.

7. A method according to claim 1, in which said step of classifying motion is performed autonomically by monitoring said input data and applying at least one criterion to said motion.

8. A method according to claim 1, in which said step of classifying motion comprises classifying said motion in a mode selected from the group comprising at least one of:
smoothing mode, attempt mode and resolution mode.

9. In a computer system displaying data on a screen in response to inputs from a pointing device manipulated by a user, said system comprising operating software and receiving software means for receiving input data from said pointing device and displaying points on a screen, compensation software that intercepts data from said pointing device, modifies the intercepted data to form modified data and passes said modified data to said receiving software means, which modified data is modified to compensate at least partially for a disability of the user.

10. A computer system according to claim 9, in which said compensation software smooths data from said pointing device.

11. A computer system according to claim 10, in which said compensation software generates compensation parameters in response to said input data, stores said parameters together with an identification of the user who generated the input data and retrieves said parameters when said user operates said computer system.

12. A computer system according to claim 11, in which said compensation software stores said parameters together with an identification of the application program that was running when said parameters were generated and retrieves said parameters when said user operates said computer system with said application program.

13. A computer system according to claim 9, in which said compensation software monitors said input data and alters the spatial resolution of said input data in response to a pattern of input data.

14. A computer system according to claim 13, in which said compensation software generates compensation parameters in response to said input data, stores said parameters together with an identification of the user who generated the input data and retrieves said parameters when said user operates said computer system.

15. A computer system according to claim 14, in which said compensation software stores said parameters together with an identification of the application program that was running when said parameters were generated and retrieves said parameters when said user operates said computer system with said application program.

16. A computer system according to claim 10, in which said compensation software monitors said input data and alters the spatial resolution of said input data in response to a pattern of input data.

17. A computer system according to claim 14, in which said compensation software generates compensation parameters in response to said input data, stores said parameters together with an identification of the user who generated the input data and retrieves said parameters when said user operates said computer system.

18. A computer system according to claim 17, in which said compensation software stores said parameters together with an identification of the application program that was running when said parameters were generated and retrieves said parameters when said user operates said computer system with said application program.

19. An article of manufacture in computer readable form comprising means for performing a method for operating in a computer system displaying data on a screen in response to inputs from a pointing device manipulated by a user, said system comprising operating software and receiving software means for receiving input data from said pointing device and displaying points on a screen, intercepting data from said pointing device, modifying the intercepted data to form modified data and passing said modified data to said receiving software means, which modified data is modified to compensate at least partially for a disability of the user, a method of classifying motion of said pointing device in one of at least two modes and applying stored parameters to modify said intercepted data according to the mode currently classified.

20. An article of manufacture according to claim 19, in which said step of classifying motion is performed autonomically by monitoring said input data and applying at least one criterion to said motion.

21. An article of manufacture according to claim 20, in which said step of classifying motion comprises classifying said motion in a mode selected from the group comprising at least one of:
smoothing mode, attempt mode and resolution mode.
